(19) United States
(12) Patent Application Publication
(10) Pub. No.: US 2008/0110652 A1
(43) Pub. Date: May 15, 2008

(54) Method of Detecting Nail Storage State

(76) Inventor: Wan-Fu Wen, Taipei Hsien (TW)

Correspondence Address: Wen-Chin Hu, 4331 Stevens Battle Lane, Fairfax, VA, 22033, US

(21) Appl. No.: 11/559,738

(22) Filed: Nov. 14, 2006

(51) Int. Cl. B25B 21/02

(52) U.S. Cl. 173/1; 227/2

(57) ABSTRACT

A method of detecting a nail storage state of a magazine employed in a nail gun includes: providing a nail gun having a magazine and a nail hitting groove connected with the magazine; providing at least one sensor disposed on the nail gun for detecting the storage state of the nails in the magazine or times of hitting nails of the nail gun to generate at least one signal; providing a display device or a sound generating device on the nail gun for receiving the at least one signal to generate sounds, texts, or numerals to indicate the user to be aware of the nail storage state of the magazine. The user is conveniently to know the quantity of the storage nails and the time to supplement the nails.

### BACKGROUND

The present invention relates to a method of detecting nail storage state of nail guns, and more particularly to a method of detecting and indicating the nail storage state of a magazine by at least one sensor, the magazine is employed in a nail gun having nail hitting groove.

Typical pneumatic nail gun or palm nailer generally includes a nail hitting groove and a nail storage magazine connected with the nail hitting groove, and a plurality of nails are aligned in the magazine. The nails in the magazine may sequentially be introduced into the nail hitting groove and may be hit by a hitting post of the nail gun.

The typical pneumatic nail gun or the palm nailer also generally includes a stop hitting mechanism to make the trigger thereof in an invalidation state for stopping driving the hitting post when the nails in the magazine are exhausted. Then it will indicate the user to supplement the nails.

However, the stop hitting mechanism is not capable of directly detecting the nail storage state of the magazine. Then the user can not clearly and surely be aware of the nail storage state of the magazine, and the user may not be indicated before the nails in the magazine being exhausted.

Accordingly, what is needed is a method of detecting nail storage state of a magazine employed in a nail gun or a palm nailer that can overcome the above-described deficiencies.

### BRIEF SUMMARY

A method of detecting nail storage state of a magazine is capable of indicating the user to supplement the nails when the nails in the magazine is to be exhausted, and is capable of making the user to know the storage quantity and state of the nails of the magazine during the period of using the nail gun employing the magazine, so as to make the nail gun capable of conveniently used.

The method of detecting nail storage state of a magazine connecting with a nail hitting groove of a nail gun, which includes: providing at least one sensor disposed on the nail gun for detecting the state of the nails in the magazine or times of hitting nails of the nail gun to generate at least one signal; providing a display device or a sound generating device on the nail gun for receiving the at least one signal to generate sounds, texts, or numerals to indicate the user to be aware of the nail storage state of the magazine.

The method further includes: providing a nail fully storage sensor for detecting the nail storage state and generating a nail expending signal when it detects that the storage quantity of the nails is less than a certain nail storage quantity; then the display device or the sound generating device receives the nail expending signal so as to generate sounds, texts, or numerals to indicate the user to be aware of the nail expending state of the magazine.

The method further includes: providing a nail supplement storage sensor for detecting the nail storage state and generating a nail supplement signal when it detects that the storage quantity of the nails is less than a certain nail storage quantity; then the display device or sound generating device receives the nail supplement signal so as to generate sounds, texts, or numerals to indicate the user to be aware of the nail supplement state of the magazine.

The method further includes: providing a nail hitting sensor, which is disposed in the nail hitting groove or the trigger of the nail gun for receiving the nail expending signal or the nail supplement signal; the hitting sensor detects the times of the hitting post hitting the nails, or the trigger being triggered so as to generate a residual nail storage signal; then the display device or sound generating device receives the residual nail storage signal so as to generate sounds, texts, or numerals to indicate the user to be aware of the residual nail storage state of the magazine.

Furthermore, the nail fully storage sensor generates a nail fully storage signal when it detects that the quantity of the nails is larger than or equal to a certain quantity; then the display device or sound generating device receives the nail fully storage signal so as to generate sounds, texts, or numerals to indicate the user to be aware of the nail fully storage state of the magazine.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a flow chart of a method of detecting nail storage state of a magazine of a nail gun according to an embodiment of the present invention, which includes: providing a sensor disposed on the nail gun for detecting the nail storage state or the times of hitting nails;

FIG. 2 is a schematic, side view of the nail gun, showing a display device disposed on the nail gun that is driven by a battery disposed on the nail gun;

FIG. 3 is an enlarged view of part of the nail gun of FIG. 2, showing a nail supplement sensor disposed adjacent to a nail groove;

FIG. 4 is a detail flow chart of FIG. 1, showing the process of generating a nail supplement signal when the quantity of the nails is less than a certain quantity;

FIG. 5 is an enlarged, cross-sectional view of the magazine of FIG. 3, showing the nail supplement sensor having a detecting light beams emitting terminal and a detecting light beams receiving terminal;

FIG. 6 is an schematic view of the magazine of FIG. 3, showing a quantity of residual nails being the quantity of the nails that can be contained between the nail supplement sensor and the nail groove;

FIG. 7 is another enlarged, cross-sectional view of the magazine of FIG. 3, showing the detecting light beams emitted by the emitted terminal being blocking by the nails;

FIG. 8 is further another enlarged, cross-sectional view of the magazine of FIG. 3, showing the detecting light beams emitted by the emitted terminal being received by the receiving terminal;

FIG. 9 is a flow chart of a method of detecting nail storage state of a magazine of a nail gun according to another embodiment of the present invention, showing a nail hitting sensor generating an residual nail storage signal by detecting the times of hitting nails;

FIG. 10 is an enlarged, cross-sectional view of a nail hitting groove of the nail gun of FIG. 9, showing the nail hitting sensor disposed at a top portion of the nail hitting groove for detecting the times of hitting the nails therein;

FIG. 11 is another enlarged, cross-sectional view of the nail hitting groove of the nail gun of FIG. 9, showing the hitting post will move to the region being detecting by the nail hitting sensor when the hitting post move to hit the nails;

FIG. 12 is an enlarged, cross-sectional view of part of FIG. 11, showing the detecting light beams emitted by the nail hitting sensor are reflected by the hitting post so as to make the hitting post be detected;

FIG. 13 is a flow chart of a method of detecting nail storage state of a magazine of a nail gun according to further another embodiment of the present invention, showing a process of generating a nail expending signal when the quantity of the nails is less than a certain quantity of nails;

FIG. 14 is a schematic of a magazine of the nail gun, showing the quantity of the nails is the quantity of the nails being contained between the nail fully storage sensor and the nail groove; and

FIG. 15 is further another flow chart of a method of detecting nail storage state of a magazine of a nail gun according to further another embodiment of the present invention, showing a process of cooperatively operating a nail supplement sensor, a nail fully storage sensor, a nail hitting sensor and a display device as well as a sound generating device.

### DETAILED DESCRIPTION

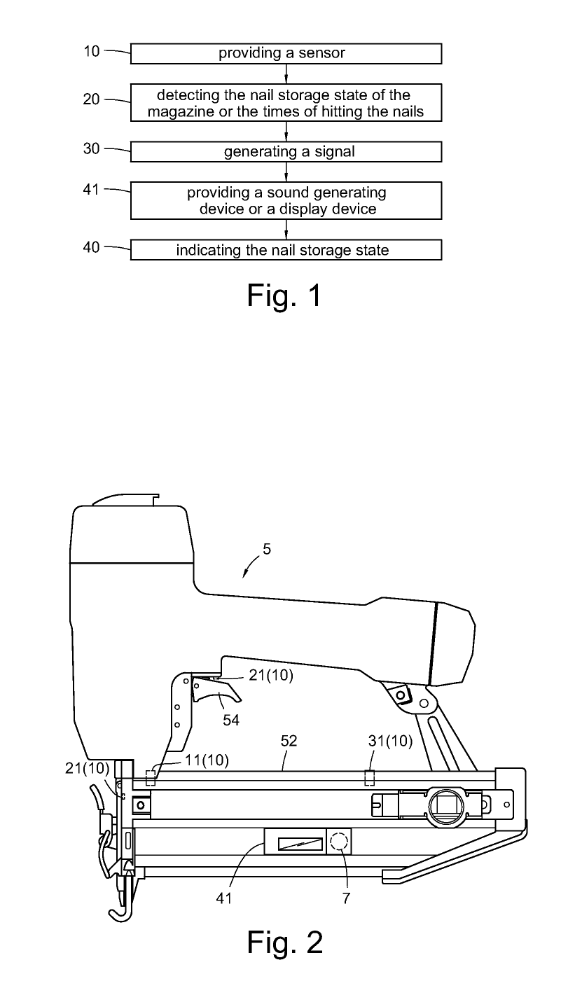

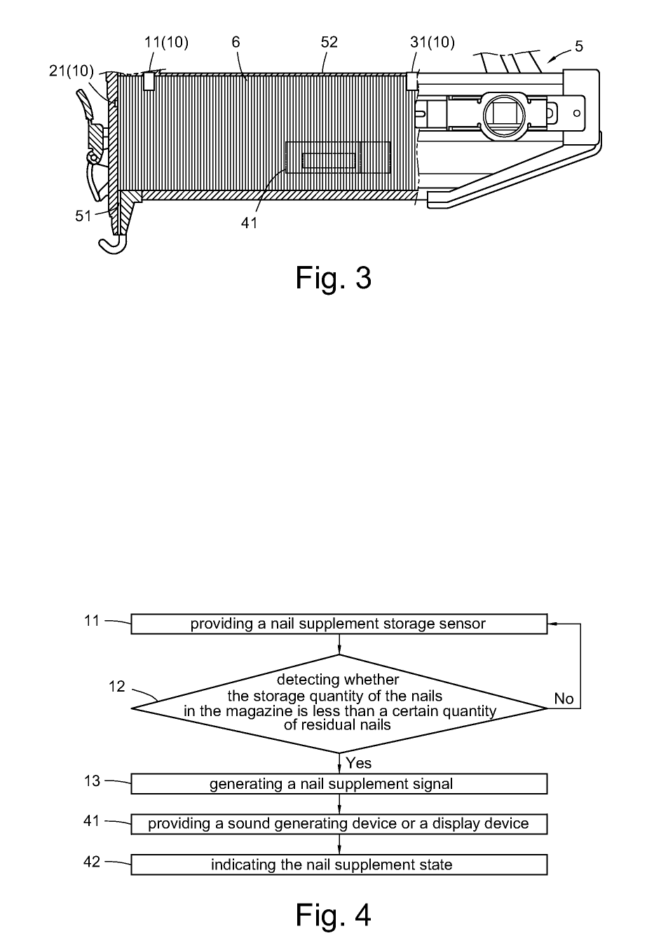

Referring to FIG. 1, a flow chart of a method of detecting a nail storage state is shown. The method is employed in a nail gun 5 having a magazine 52 and a nail hitting groove 51 connected with the magazine 52 (shown in FIGS. 2 and 3). The method provides at least one sensor 10 disposed on the nail gun 5 for detecting the storage state of the nails in the magazine 52 or times of hitting nails (step 20) to generate at least one signal (step 30); and providing a display device or a sound generating device 41 on the nail gun 5 for receiving the at least one signal to generate sounds, texts, or numerals to indicate the user to be aware of the nail storage state of the magazine 52 (step 40).

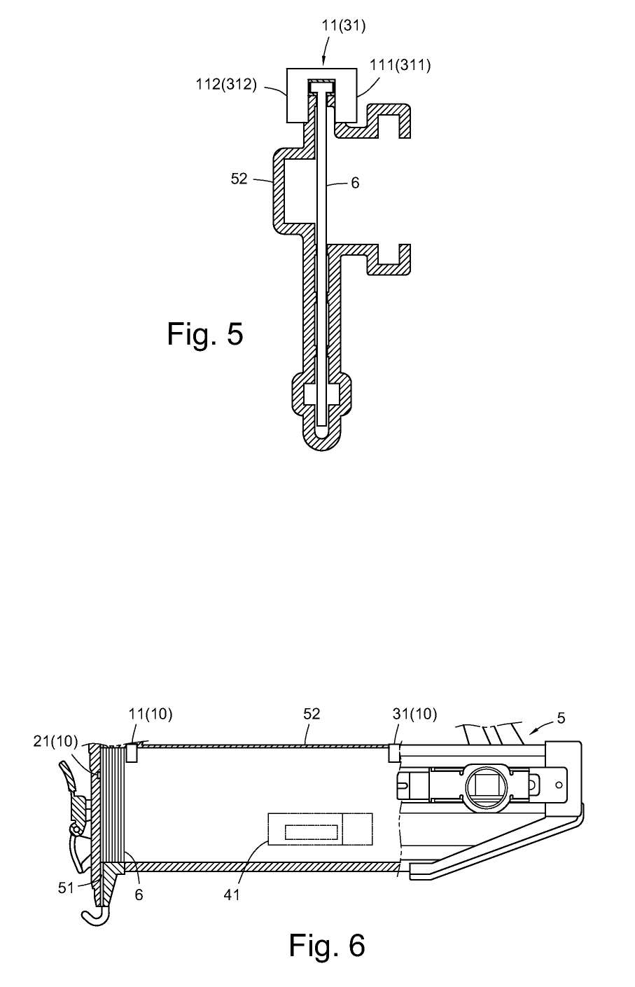

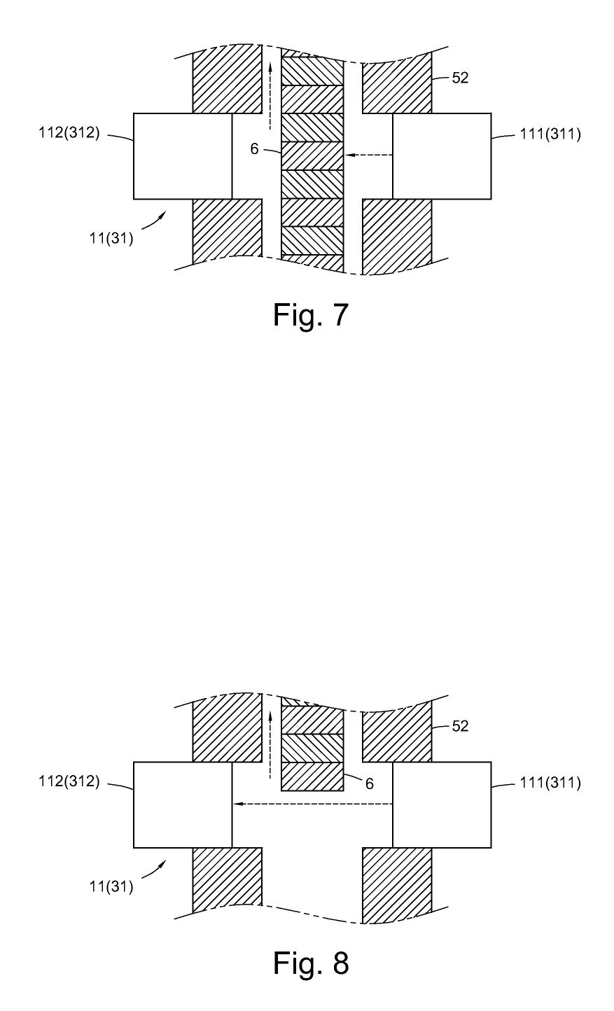

Referring to FIG. 4, a detail flow chart of the method of detecting the nail storage is shown. The sensor 10 is a nail supplement sensor 11 disposed in the magazine 52 adjacent to the nail hitting groove 51 (shown in FIGS. 3 and 5). The nail supplement sensor 11 (shown in FIG. 6) detects whether the quantity of the nails 6 stored in the magazine 52 is less than a certain quantity of residual nails (step 12), whereby, the certain quantity of residual nails is the quantity of the nails 6 contained between the nail supplement sensor 11 and the nail hitting groove 51. The nail supplement sensor 11 includes a detecting light beams emitting terminal 111 (shown in FIGS. 5 and 7) and a detecting light beams receiving terminal 112 opposite to the emitting terminal 111. When the quantity of the nails 6 stored in the magazine 52 is larger than or equal to the certain quantity of residual nails (shown in FIG. 3), the detecting light beams emitted by the emitting terminal 111 is blocked by the nails 6 (shown in FIG. 7). At this time, the nail supplement sensor 11 may continuously detect the nail storage state of the magazine 52 if it detects that the quantity of the nails 6 stored in the magazine 52 is not less than the certain quantity of the residual nails (shown in FIG. 4). On the other hand, when the quantity of the nails 6 stored in the magazine 52 is less than the certain quantity of the residual nails (shown in FIGS. 6 and 8), the detecting light beams emitted by the emitting terminal 111 may be received by the receiving terminal 112. At this time, the nail supplement sensor 11 may generate a nail supplement signal (step 13) when the quantity of the nails 6 stored in the magazine 52 is less than the certain quantity of the residual nails.

Moreover, the display device or the sound generating device 41 disposed in the nail gun or the magazine 52 (shown in FIGS. 2 and 3) may be induced by the nail supplement signal to generate sounds, texts, or numerals to indicate the user to be aware of the nail supplement state of the magazine 52 (step 42). The display device or the sound generating device 41 is driven by a power supply 7 (shown in FIG. 2) disposed on the nail gun or the magazine 52. The power supply 7 may be a battery disposed on the nail gun or the magazine 52, or a circuit capable of generating electricity itself.

With these configurations, it is capable of detecting the nail storage state of the magazine 52 and the nail hitting groove 51 of the nail gun 5 and indicating the user be aware of the nail storage state, which facilitate utilization of the nail gun 5 because of making the user be aware of the quantity of the stored nails and the timing to supplement the nails.

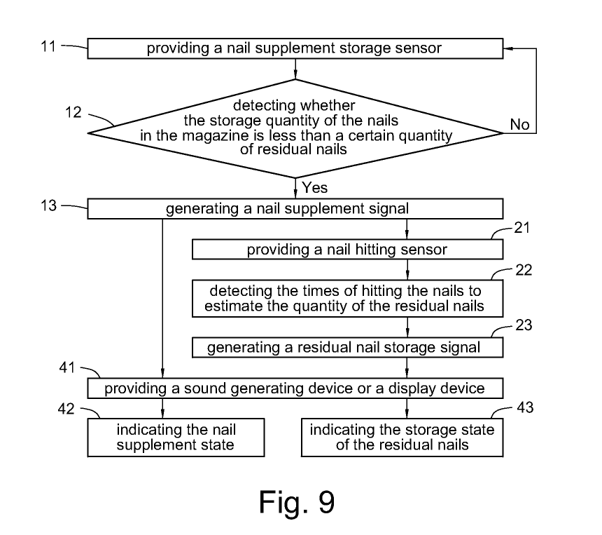

Referring to FIG. 9, another flow chart of the method of detecting nail storage state is shown. The nail supplement sensor 11 (shown in FIGS. 3 and 5) detects whether the quantity of the nails 6 stored in the magazine 52 is less than a certain quantity of residual nails (step 12). When the quantity of the nails 6 stored in the magazine 52 is not less than the certain quantity of residual nails, the nail supplement sensor 11 continuously detects the nail storage state of the nails 6 stored in the magazine 52 (shown in FIG. 9). When the quantity of the nails 6 stored in the magazine 52 is less than the certain quantity of the residual nails, the nail supplement sensor 11 generates a nail supplement signal (step 13). The display device or the sound generating device 41 may be induced by the nail supplement signal to generate sounds, texts, or numerals to indicate the user to be aware of the nail supplement state of the magazine 52 (step 42).

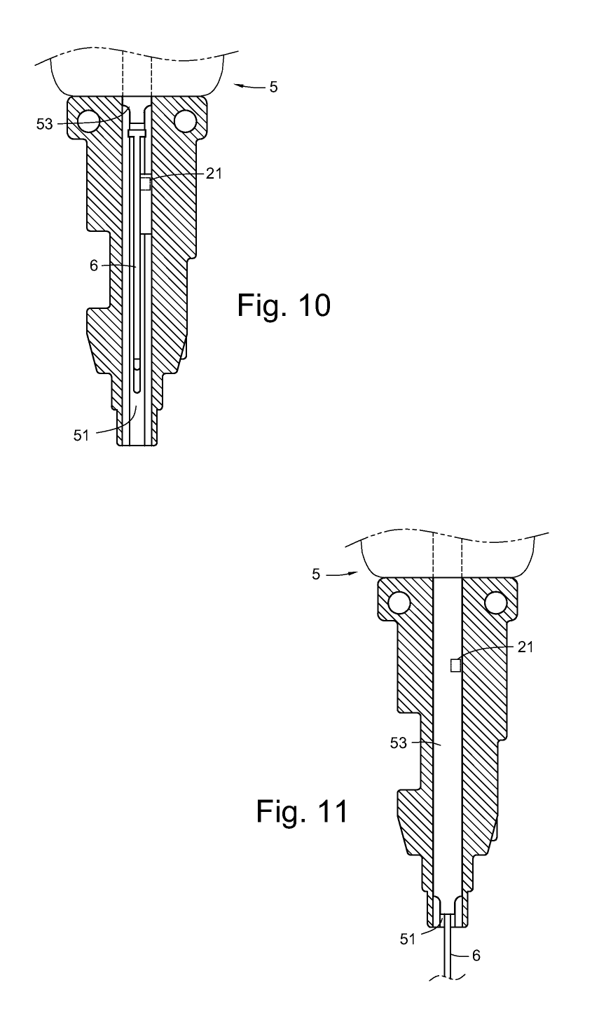

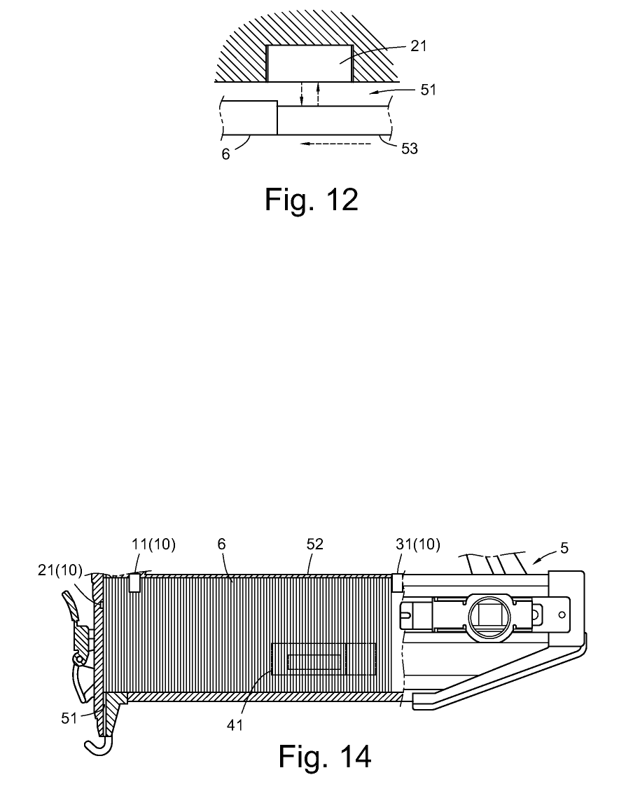

Moreover, the nail gun 5 further includes a nail hitting sensor 21 disposed at a top portion of the nail hitting groove 51 or in a trigger 54 of the nail gun 5 (shown in FIGS. 2, 3 and 10). The nail hitting sensor 21 is driven by the nail supplement signal to detect the times of hitting nails of a hitting post 53 in the nail hitting groove 51 and the times of pressing the trigger 54 so as to estimate the quantity of residual nails stored in the magazine 52 (step 22). The nail hitting sensor 21 is capable of emitting and receiving detecting light beams, which is driven by the power supply 7. The detecting light beams emitted by the nail hitting sensor 21 may not response relative to the hitting post 53 before the hitting post 53 hitting the nails 6 (shown in FIG. 10), the times of hitting nails may not be calculated. On the other hand, when the hitting post 53 hits the nail 6, the detecting light beams emitted by the nail hitting sensor 21 may be reflected by the hitting post 53, then the nail hitting sensor 21 may receive the reflective detecting light beams. Therefore, the nail hitting sensor 21 may calculate the times of hitting nails 6 via the individual reflective detecting light beams so as to generate a residual nail storage signal by calculate the times of hitting nails (step 23). The display device or the sound generating device 41 may be induced by the residual nail storage signal to generate sounds, texts, or numerals to indicate the user to be aware of the residual nail storage state of the magazine 52 (step 43).

With these configurations, the user may clearly know the quantity of the residual nails stored in the magazine 52 and the timing to supplement the nails.

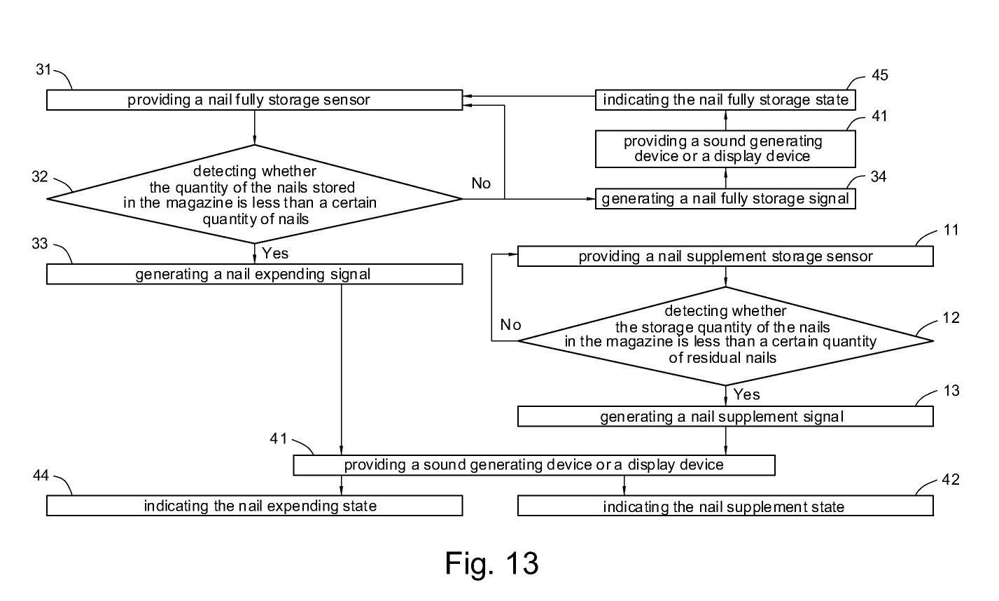

Referring to FIG. 13, a flow chart of another method of detecting nail storage state according to the present invention is shown.

The sensor 10 includes a nail fully storage sensor 31 (shown in FIGS. 2, 3 and 5) disposed in the magazine 52. The nail fully storage sensor 31 detects whether the quantity of the nails 6 stored in the magazine 52 is less than a certain quantity of nails (step 32), whereby, the certain quantity of nails is the quantity of the nails 6 contained between the nail fully storage sensor 31 and the nail hitting groove 51 (shown in FIG. 14). The nail fully storage sensor 31 includes a detecting light beams emitting terminal 311 (shown in FIGS. 5 and 7) and a detecting light beams receiving terminal 312 opposite to the emitting terminal 311. The nail fully storage sensor 31 is also driven by the power supply 7. When the quantity of the nails 6 stored in the magazine 52 is larger than or equal to the certain quantity of nails, the detecting light beams emitted by the emitting terminal 311 is blocked by the nails 6. At this time, the nail fully storage sensor 31 may continuously detect the nail storage state of the magazine 52 if it detects that the quantity of the nails 6 stored in the magazine 52 is not less than the certain quantity of the nails (shown in FIG. 13), or may generate a nail fully storage signal for driving the display device or the sound generating device 41 (step 45), which may be induced by the nail fully storage signal to generate sounds, texts, or numerals to indicate the user to be aware of the nail fully storage state of the magazine 52 (step 34). On the other hand, when the quantity of the nails 6 stored in the magazine 52 is less than the certain quantity of the nails (step 32, and shown in FIGS. 8, 13 and 14), the detecting light beams emitted by the emitting terminal 311 may be received by the receiving terminal 312. At this time, the nail fully storage sensor 31 may generate a nail expending signal (step 33). The display device or the sound generating device 41 may be induced by the nail expending signal to generate sounds, texts, or numerals to indicate the user to be aware of the nail expending state of the magazine 52 (step 44).

Moreover, the nail supplement sensor 11 (shown in FIGS. 3 and 5) detects whether the quantity of the nails 6 stored in the magazine 52 is less than a certain quantity of residual nails (step 12). When the quantity of the nails 6 stored in the magazine 52 is not less than the certain quantity of residual nails, the nail supplement sensor 11 continuously detects the nail storage state of the nails 6 stored in the magazine 52 (shown in FIG. 13). When the quantity of the nails 6 stored in the magazine 52 is less than the certain quantity of the residual nails, the nail supplement sensor 11 generates a nail supplement signal (step 13). The display device or the sound generating device 41 may be induced by the nail supplement signal to generate sounds, texts, or numerals to indicate the user to be aware of the nail supplement state of the magazine 52 (step 42).

With these configurations, the user may clearly know the nail expending state of the nails 6, and the quantity of the residual nails 6 stored in the magazine 52, as well as the timing to supplement the nails.

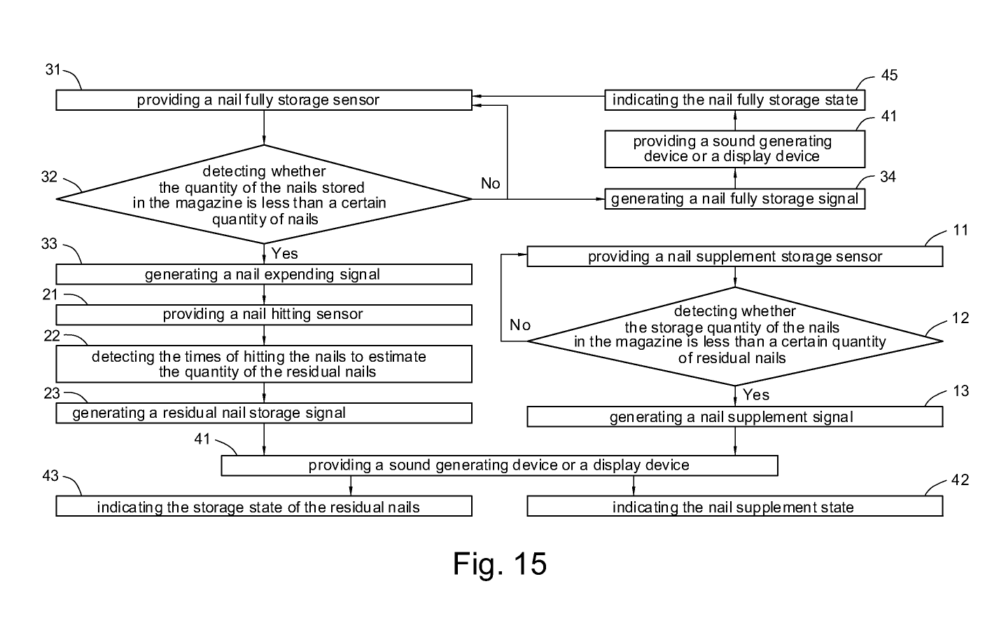

Referring to FIG. 15, a flow chart of further another method of detecting nail storage state according to the present invention is shown.

The nail fully storage sensor 31 (shown in FIG. 3) detects whether the quantity of the nails 6 stored in the magazine 52 is less than a certain quantity of nails (step 32). When the quantity of the nails 6 stored in the magazine 52 is larger than or equal to the certain quantity of nails, the nail fully storage sensor 31 may continuously detect the nail storage state of the magazine 52 (shown in FIG. 15), or may generate a nail fully storage signal for driving the display device or the sound generating device 41 (step 45), which may be induced by the nail fully storage signal to generate sounds, texts, or numerals to indicate the user to be aware of the nail fully storage state of the magazine 52 (step 34). On the other hand, when the quantity of the nails 6 stored in the magazine 52 is less than the certain quantity of the nails (shown in FIGS. 8 and 14), the nail fully storage sensor 31 may generate a nail expending signal (step 33).

Moreover, the nail hitting sensor 21 (shown in FIGS. 2, 3 and 10) is driven by the nail expending signal 33 to detect the times of hitting nails of the hitting post 53 (shown in FIG. 10) in the nail hitting groove 51 and the times of pressing the trigger 54 so as to estimate the quantity of residual nails stored in the magazine 52 (step 22) to generate a residual nail storage signal (step 23). The display device or the sound generating device 41 may be induced by the residual nail storage signal 23 to generate sounds, texts, or numerals to indicate the user to be aware of the residual nail storage state of the magazine 52 (step 43).

Furthermore, the nail supplement sensor 11 (shown in FIGS. 3 and 5) detects whether the quantity of the nails 6 stored in the magazine 52 is less than a certain quantity of residual nails (step 12). When the quantity of the nails 6 stored in the magazine 52 is not less than the certain quantity of residual nails, the nail supplement sensor 11 continuously detects the nail storage state of the nails 6 stored in the magazine 52 (shown in FIG. 13). When the quantity of the nails 6 stored in the magazine 52 is less than the certain quantity of the residual nails, the nail supplement sensor 11 generates a nail supplement signal (step 13). The display device or the sound generating device 41 may be induced by the nail supplement signal to generate sounds, texts, or numerals to indicate the user to be aware of the nail supplement state of the magazine 52 (step 42).

With these configurations, the user may clearly know the quantity of the residual nails stored in the magazine 52 and the timing to supplement the nails.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method of detecting nail storage state, comprising:
providing a nail gun having a magazine and a nail hitting groove connected with the magazine;
providing at least one sensor disposed on the nail gun for detecting the storage state of the nails in the magazine or times of hitting nails of the nail gun to generate at least one signal;
providing a display device or a sound generating device on the nail gun for receiving the at least one signal to generate sounds, texts, or numerals to indicate the user to be aware of the nail storage state of the magazine.

2. The method of detecting nail storage state as claimed in claim 1, wherein the at least one sensor is a nail supplement sensor disposed in the magazine adjacent to the nail hitting groove, the nail supplement sensor generates a nail supplement signal when it detects that a quantity of the nails in the magazine is less than a certain nail storage quantity, and then the display device or the sound generating device receives the nail supplement signal so as to generate sounds, texts, or numerals to indicate the user to be aware of the nail supplement state of the magazine.

3. The method of detecting nail storage state as claimed in claim 1, wherein the at least one sensor is a nail hitting sensor disposed in the nail hitting groove or a trigger of the nail gun, the nail hitting sensor generates a residual nail storage signal by detecting the times of a hitting post hitting the nails or the trigger being triggered, and then the display device or sound generating device receives the residual nail storage signal so as to generate sounds, texts, or numerals to indicate the user to be aware of the nail residual storage state of the magazine.

4. The method of detecting nail storage state as claimed in claim 1, wherein the at least one sensor comprises a nail supplement sensor disposed in the magazine adjacent to the nail hitting groove, the nail supplement sensor generates a nail supplement signal when it detects that a quantity of the nails in the magazine is less than a certain nail storage quantity, and then the display device or the sound generating device receives the nail supplement signal so as to generate sounds, texts, or numerals to indicate the user to be aware of the nail supplement state of the magazine; and a nail hitting sensor disposed in the nail hitting groove or a trigger of the nail gun, the nail hitting sensor generates a residual nail storage signal by detecting the times of a hitting post hitting the nails or the trigger being triggered, and then the display device or sound generating device receives the residual nail storage signal so as to generate sounds, texts, or numerals to indicate the user to be aware of the residual nail storage state of the magazine.

5. The method of detecting nail storage state as claimed in claim 1, wherein the at least one sensor comprises a nail fully storage sensor disposed in the magazine, the nail fully storage sensor generates a nail expending signal for detecting the nail storage state and generating a nail expending signal when it detects that a quantity of the storage nails is less than a certain nail storage quantity, and then the display device or sound generating device receives the nail expending signal so as to generate sounds, texts, or numerals to indicate the user to be aware of the nail expending state of the magazine; and a nail supplement sensor disposed in the magazine adjacent to the nail hitting groove, the nail supplement sensor generates a nail supplement signal when it detects that a quantity of the nails in the magazine is less than a certain nail storage quantity, and then the display device or the sound generating device receives the nail supplement signal so as to generate sounds, texts, or numerals to indicate the user to be aware of the nail supplement state of the magazine.

6. The method of detecting nail storage state as claimed in claim 5, wherein the nail fully storage sensor generates a nail fully storage signal when it detects that a quantity of the storage nails is larger than or equal to a certain nail storage quantity, and then the display device or sound generating device receives the nail fully storage signal so as to generate sounds, texts, or numerals to indicate the user to be aware of the nail fully storage state of the magazine.

7. The method of detecting nail storage state as claimed in claim 1, wherein the at least one sensor comprises a nail fully storage sensor disposed in the magazine, the nail fully storage sensor generates a nail expending signal for detecting the nail storage state and generating a nail expending signal when it detects that a quantity of the storage nails is less than a certain nail storage quantity, and then the display device or sound generating device receives the nail expending signal so as to generate sounds, texts, or numerals to indicate the user to be aware of the nail expending state of the magazine; a nail hitting sensor disposed in the nail hitting groove or a trigger of the nail gun, the nail hitting sensor generates a residual nail storage signal by detecting the times of a hitting post hitting the nails or the trigger being triggered, and then the display device or sound generating device receives the residual nail storage signal so as to generate sounds, texts, or numerals to indicate the user to be aware of the residual nail storage state of the magazine; and a nail supplement sensor disposed in the magazine adjacent to the nail hitting groove, the nail supplement sensor generates a nail supplement signal when it detects that a quantity of the nails in the magazine is less than a certain nail storage quantity, and then the display device or the sound generating device receives the nail supplement signal so as to generate sounds, texts, or numerals to indicate the user to be aware of the nail supplement state of the magazine.

8. The method of detecting nail storage state as claimed in claim 7, wherein the nail fully storage sensor generates a nail fully storage signal when it detects that a quantity of the storage nails is larger than or equal to a certain nail storage quantity, and then the display device or sound generating device receives the nail fully storage signal so as to generate sounds, texts, or numerals to indicate the user to be aware of the nail fully storage state of the magazine.
